(19) United States
(12) Patent Application Publication
(10) Pub. No.: US 2006/0172676 A1
(43) Pub. Date: Aug. 3, 2006

(54) Device and method for air distribution in a vehicle

(75) Inventors: Gunter Ebner, Korntal-Munchingen (DE); Walter Wolf, Oppenweiler-Zell (DE)

Correspondence Address: FOLEY AND LARDNER LLP;SUITE 500, 3000 K STREET NW, WASHINGTON, DC, 20007, US

(73) Assignee: BEHR GmbH & CO. KG, Stuttgart (DE)

(21) Appl. No.: 10/534,022

(22) PCT Filed: Oct. 29, 2003
(86) PCT No.: PCT/EP03/11986

§ 371 Date: Jan. 13, 2006

(30) Foreign Application Priority Data
Nov. 5, 2002 (DE) 102 51 760.6

(51) Int. Cl. B60H 1/34

(52) U.S. Cl. 454/152

(57) ABSTRACT

The aim of the invention is to develop a particularly simple, small-sized and low cost device for air distribution in a car cabin. The inventive ventilating element (4) for generating an air flow (L) is connected to at least one flow channel (6) leading to several exhaust air elements (10) which are connected to the cabin (2). The inventive flow channel (6) is embodied in the form of a multichamber common channel (16) which is provided with several exhaust air elements (10) and comprises several output openings (8) leading directly to the exhaust air elements (10).

The invention relates to a device for air distribution in the interior of a vehicle having a plurality of air flow discharge elements (referred to as discharge elements or outlets, for short) which connect one or more flow ducts, especially air ducts, connected to a heating or air conditioning system, to the vehicle interior. The invention furthermore relates to a method for air distribution in the vehicle interior and to a flow duct particularly suited to air distribution.

Vehicles, such as land-based vehicles, watercraft and aircraft, especially the passenger interior thereof, are usually heated or air-conditioned. For this purpose air flow discharge elements or outlet points, which are connected by separate flow ducts to a heating or air conditioning system, are generally provided at a number of points deemed to be suitable. This takes up a large overall space. An arrangement of flow ducts running through the outer shell of the vehicle means that the overall space available is very limited. Reducing the duct cross-section causes an increase in the flow velocity of a fluid flowing through the flow duct, which in turn leads to increased noise, which has a considerable adverse affect on passenger comfort.

Furthermore, such a heavily ramified air distribution device is very heavy, since the flow or air distribution ducts are usually formed from injection-molded, rigid and dimensionally stable shells or blow-molded parts. Complex geometries make the manufacture of such rigid flow ducts particularly expensive and cost-intensive. DE 200 21 556 U1, for example, discloses an airtight hose formed from a flexible material and used as fluid or flow duct, which requires a coating to prevent sticking. Moreover, such a hose can be connected only by bonding or welding, which owing to the limited overall space is very costly with regard to precise positioning.

The object of the invention, therefore, is to specify a device for air distribution in the interior of a vehicle which is particularly simple, space-saving and inexpensive and is of less weight compared to the prior art. A further object is to specify a particularly suitable flow duct and a method for air distribution in the interior of the vehicle which particularly lends itself to individual adaptation.

According to the invention the first aforementioned object is achieved by a device for air distribution in the interior of a vehicle having a ventilating element for generating an air flow and having at least one flow duct connected to the ventilating element together with a plurality of air discharge elements leading into the interior, the flow duct taking the form of a common multi-chamber duct for a plurality of air discharge elements and having a plurality of outlet openings which open directly into the air discharge elements.

The invention stems from the consideration that a device for air distribution in the interior of a vehicle needs to be simplified in such a way as to provide a direct air delivery to all air discharge elements avoiding a complex, ramified ducting system. In this case the respective air discharge element has access to a volume of air common to all air discharge elements. In addition to simplifying the ducting, it was also intended to reduce the weight significantly and to promote the flow through the ducting in such a way that swirling of the fluid flowing through the flow duct and so-called dead zones are reliably prevented. For this purpose a single, common flow duct is formed for a plurality of air discharge elements or outlet points, the duct having openings arranged at suitable points by way of which the fluid is, if necessary, mixed and temperature-regulated at the air discharge elements. For this purpose the flow duct is formed as a multi-chamber duct. As a result the number of outlets from a heating or air conditioning system is significantly reduced. A single flow duct of this type having a plurality of variable, inserted outlet openings permits an especially simple and standardizable air distribution device, which takes up minimal overall space. The simple construction and the particularly variable adjustment of the outlet openings mean that the air distribution device can be individually designed and adapted as required, so that an especially high level of heating comfort is possible.

For regulating the temperature of individual air discharge elements to individual requirements the multi-chamber duct appropriately takes the form of a two-chamber duct. For example, the multi-chamber duct comprises at least two chamber ducts or secondary ducts, in particular two so-called single-chamber ducts or also a plurality of single-chamber ducts. The one chamber duct preferably takes the form of a cold flow duct and the other a warm flow duct. In other words, a warm fluid is carried in one chamber of the multi-chamber duct and a cold fluid in the other chamber (=secondary duct or single-chamber duct). A refrigerating unit, such as an evaporator, a heating unit, such as a heating element, and/or a drier, such as a reheater is assigned to the multi-chamber duct, depending on the embodiment of the air distribution device.

Alternatively the multi-chamber duct may be sub-divided into a plurality of chamber ducts. In this case a multi-chamber duct of a larger duct cross-section may be formed from a plurality of individual chamber ducts or from one large duct with chambers separated by the insertion of walls. In addition, sections of the multi-chamber duct may be subdivided into a plurality of chamber ducts at particularly suitable points, for example in the area of a screen that is to be rapidly freed of ice or frost, the number of chambers or chamber ducts carrying a warm fluid being greater than the number of chambers or chamber ducts carrying a cold fluid. In this case an individual chamber duct preferably takes the form of a two-chamber duct or a separate mixing chamber duct. The cold fluid and the warm fluid are already mixed in the mixing chamber duct, thereby permitting an individual temperature adjustment at the relevant outlet openings of the mixing chamber duct. For this purpose each chamber duct at its outlet openings appropriately opens into an associated air discharge element. The respective outlet opening furthermore comprises at least one regulating element or a mixing element. For example, a so-called defrost outlet can be used for draft-free ventilation, where dry air can be regulated by means of a regulating element or mixing element to counter misting.

For individual adjustment of the air flow at the respective air discharge element and/or for regulating the temperature of the adjustable air flow by mixing the cold and warm air flow, the flow duct is preferably provided with at least one regulating or baffle element, for example a closing element. For example, a flap, a partition, a deflector or some other baffle part is provided as closing element. For an automatic adjustment of the air flow and regulating of the temperature of the vehicle interior a measuring sensor for registering relevant operating data is advantageously provided on at least one air discharge element. From the operating data registered, for example the interior temperature and/or the flap position at the relevant air discharge element, the air flow quantity can be automatically adjusted through corresponding control of the blower and/or the flap position, especially as a function of previously adjusted temperature settings and flow rates and/or of individual occupant-related settings on individual air discharge elements or any settings on an air conditioning system.

For an especially space-saving and simple fitting and removal of the air distribution device, the individual flow duct designed as multi-chamber duct is arranged running longitudinally and/or transversely along a vehicle shell. In a preferred embodiment the multi-chamber duct takes the form of a ring main. In this case the multi-chamber duct may also advantageously run in a layer, for example in the front area in the vicinity of a so-called engine compartment rear bulk or directly underneath a fascia or above a plane formed by a steering column and a vehicle transverse axis (so-called Y-axis). In other words, the multi-chamber duct takes the form of a sandwiched layer, the individual chamber ducts running inside the sandwich and the sandwich structure of the multi-chamber duct itself assuming a supporting function, for example for transverse and/or longitudinal reinforcement of the vehicle or some other function, for example a holding function for the fixing of functional elements such as steering and airbag.

According to the invention the object relating to the flow duct is achieved by a duct wall composed of at least partially deformable material, which is shaped forming a hose-like hollow space and is detachably and/or permanently fixed. In a preferred embodiment the material of the duct wall is fixed to a dimensionally stable surface, forming a hollow space. For example, the duct wall is in part formed from a dimensionally stable wall of an outer or inner shell of the vehicle and in part from the deformable material, which is joined to the dimensionally stable wall, forming the hollow space. Between the deformable material and the dimensionally stable wall a fluid, in particular air, is carried in individual or multiple flow ducts formed by the hollow space or multiple hollow spaces. The flow duct has areas with openings, through which the fluid can escape. This means that the additional nozzles required in the case of conventional flow ducts can possibly be dispensed with.

In cross-section, the flow duct has a U-shape or Omega-shape, depending on the number of fixing points. For particularly easy fitting and removal of the flow duct, the duct wall is detachably fixed, for example clipped or clamped. For this purpose the inner or outer shell of the vehicle has corresponding grooves, depressions, prominences, ribs or protuberances, for example. As an alternative to the divided embodiment of the flow duct, the duct wall thereof may be formed like a hose by the material itself. For fixing, the hose-shaped flow duct has a lip, which is inserted into a groove, a ribbing or a depression of the dimensionally stable wall.

For a particularly flexible and thin-walled embodiment of the flow duct, the deformable material takes the form of a film. As an alternative or in addition, the deformable material takes the form of a woven fabric-like material. Depending on the desired shape or contour and as a function of the particular material, a film is folded in a U-shape, for example and may be reinforced with a fabric. Such a reinforcing fabric may be of three-dimensional design structure, for example, in order to permit a particular contouring. For example, areas or sections of the flow duct can be impressed by a reinforcing fabric, producing a simple restriction and/or shut-off function. Alternatively or in addition, the deformable material may be provided with a profile. In this case wires or profiles, for example, are integrated into the hollow space of the flow duct. These can be provided, for example, not only in order to form film longitudinal edges but also for fixing on a fixed member or dimensionally stable vehicle body surface, such as a fascia, a center console or on a door trim panel, headliner or side wall trim panel. Alternatively perforations can be provided in the film or the fabric for fixing or positioning.

Depending on the function and the given installation parameters, the flow duct is preferably designed with a multilayer or multi-ply duct wall. In a preferred embodiment, for example, a tubular foam may be provided as insulation layer, thereby providing a duct wall with a mesh of polypropylene or polyethylene. Depending on the layering the duct wall can be constructed from a film-mesh-film layering, for example PMMA-Hi-PMMA-ASA layering (where PMMA=polymethyl methacrylate, ASA=acrylic ester-styrene-acrylonitrile-terpolymer). In addition the duct wall may also be formed from a multilayer film, so-called PMMA, ASA, ABS, PC/ASA, PC/PBT film (where PMMA=polymethyl methacrylate, ASA=acrylic ester-styrene-acrylonitrile-terpolymer, ABS=acrylonitrile-butadiene-styrene-terpolymer, PC=polycarbonate, PBT=polybutylene terephthalate). Alternatively the duct wall may be constructed from a compact film provided with a woven fabric of plastic fibers or metal fibers. Examples of this are films made from polyvinylchloride, polypropylene, polyethylene, thermoplastic polyolefin, thermoplastic polyurethanes, Teflon, EPDM, ethene thermoplastic, esther thermoplastic, PMMA/ASA films. Elastomers or thermoplastics, such as SBR (=styrene-butadiene rubber), EPM/EPDM (ethylene-polypropylene rubber), FPM, NBR (=nitrile rubber, acrylonitrile-butadiene rubber) or PE, PP, polystyrene plastics are also suitable as material for the duct wall. The use of such materials for the duct wall means that acoustic and/or thermal characteristics, such as acoustic and/or thermal insulation, can be adjusted as required, for example in sections, by means of a correspondingly designed duct wall layer structure. The flow duct preferably has a duct wall with a tear resistance of at least 1 bar excess pressure (up to 2 bar for the absolute blower pressure against closed flaps) and a temperature resistance ranging from 85° C. to at least 120° C. This ensures that under both excess pressure, for example with air discharge nozzles closed and blower switched on, and under particularly high thermal stresses, due to solar insolation, for example, the flow duct remains dimensionally and functionally stable. In addition, any sticking together of the inside of the duct wall due to moisture is also to be prevented. For this purpose the duct wall preferably has a stable wall structure. For example, the shell or the deformable material is correspondingly flexible, and in particular elastic, so that wrinkling and hence sticking is reliably avoided. At the same time the use of an elastic, in particular a rubber-like material having especially good acoustic damping characteristics suppresses the generation of noise and consequently improves the ride comfort. In a preferred embodiment an elastic, deformable and/or foldable dividing wall is arranged between two chambers of the multi-chamber duct. Such a flexibly deformable dividing wall allows the two chambers to have variably adjustable cross-sections.

According to the invention the object with regard to the method for air distribution in the interior of a vehicle is achieved in that an overall air flow is generated by means of a ventilating element and delivered to a flow duct connected to the ventilating element, an associated partial air flow in each case being drawn from the overall air flow by way of a plurality of air discharge elements opening into the interior. In other words, an individual flow duct is simultaneously used for a plurality of air discharge elements or outlet points, the associated partial air flow being branched off from the common overall air flow at the various air discharge elements and delivered into the interior. In a preferred embodiment the overall air flow is made up of the sum of all partial air flows. Alternatively the overall air flow is made up of a corresponding number of partial air flows varying as a function of the time and/or conditions. As a result the common flow duct can be used, at staggered intervals, for example, to deliver air to just a few open air discharge elements or to all air discharge elements.

The advantages obtained by the invention reside, in particular, in the fact that an especially low overall volume with multiple use of the flow duct for different air discharge elements is achieved by means of a common flow duct, in the form of multi-chamber duct, for an air distribution device. In addition the invention permits easy regulation of the temperature of the partial air flow fed into the interior through simple mixing by means of a mixing flap. Owing to the low material and component costs, the air distribution device is therefore particularly cost-effective. In addition the device and the flow duct itself have an especially low weight. The flexible design of the flow duct permits the use of standardized components. Simple constrictions or shaping of the flow duct furthermore allow provision for flow-enhancing closing and restrictor elements. The flow duct can therefore be used as lightweight ducting.

Exemplary embodiments of the invention will be explained in more detail with reference to the drawing, in which

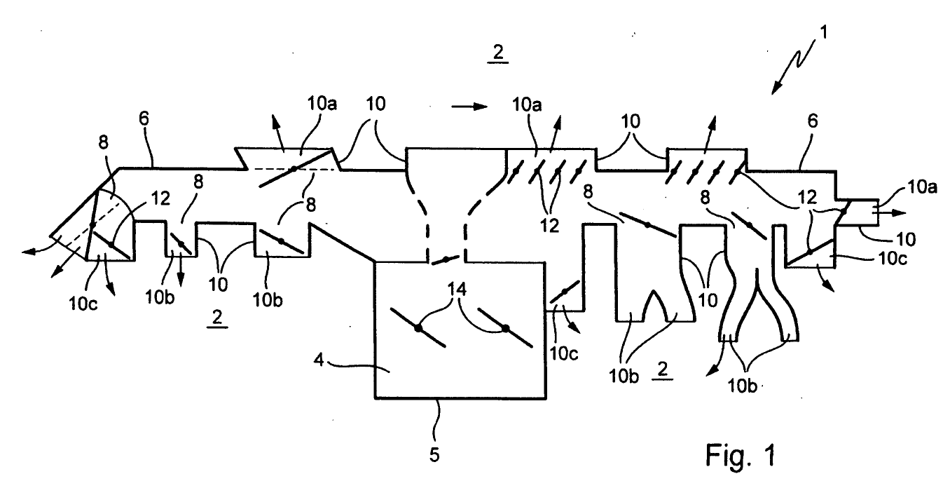

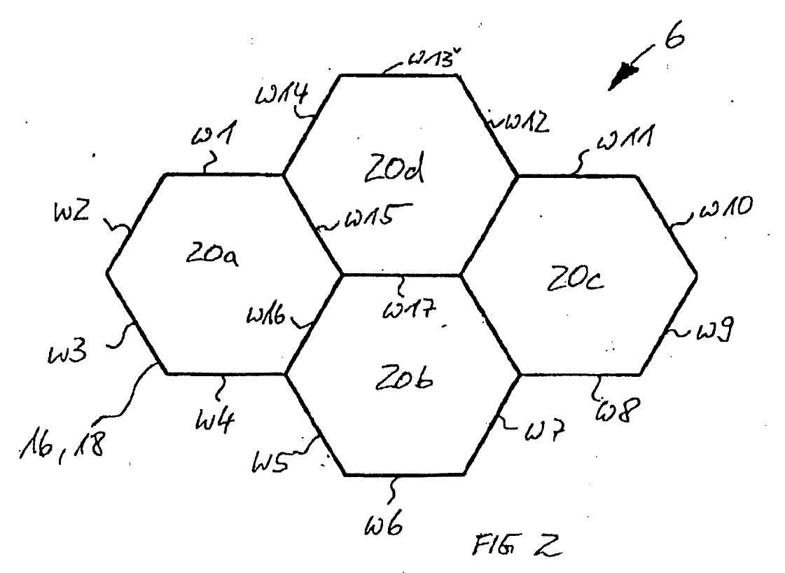

FIG. 1 shows a schematic representation of a device for air distribution in a vehicle interior having a common flow duct,

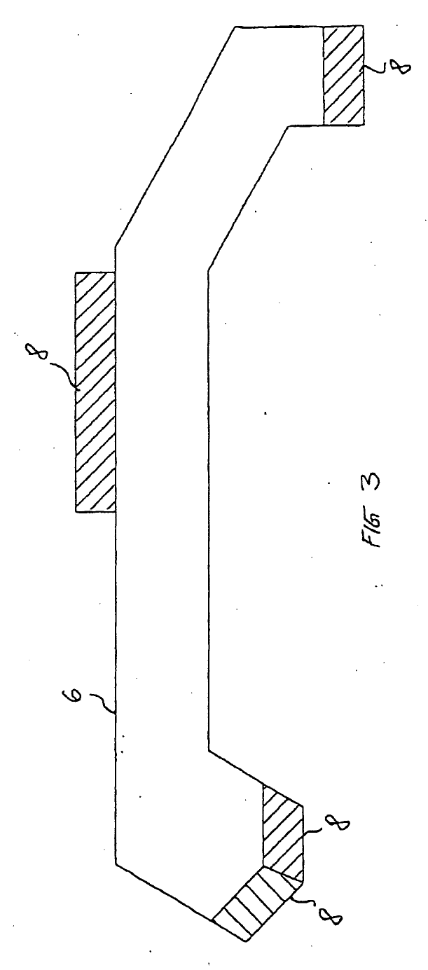

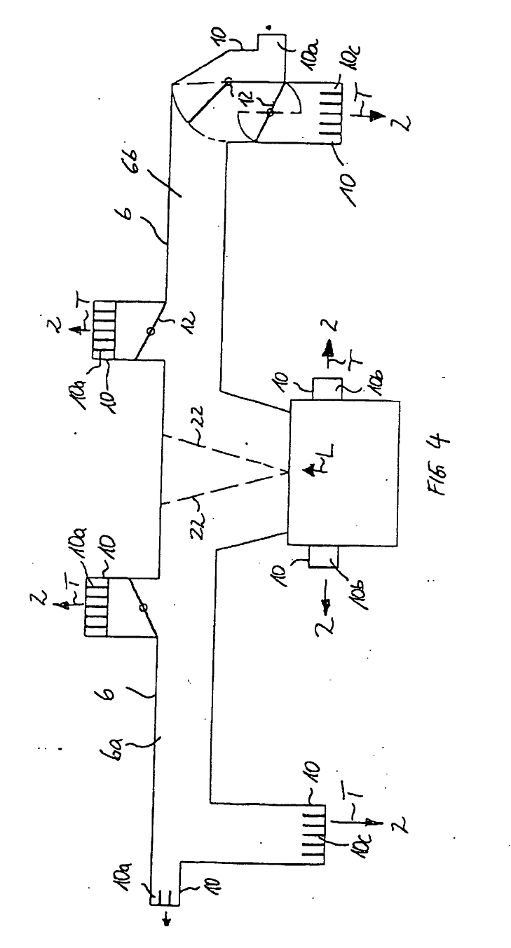

FIG. 2 shows a schematic cross-sectional view of a flow duct in the form of a multi-chamber duct,

FIG. 3 shows a schematic plan view of a common flow duct,

FIG. 4 shows a schematic representation of a further device for air distribution having a common flow duct for time and/or condition-dependent air flow ducting,

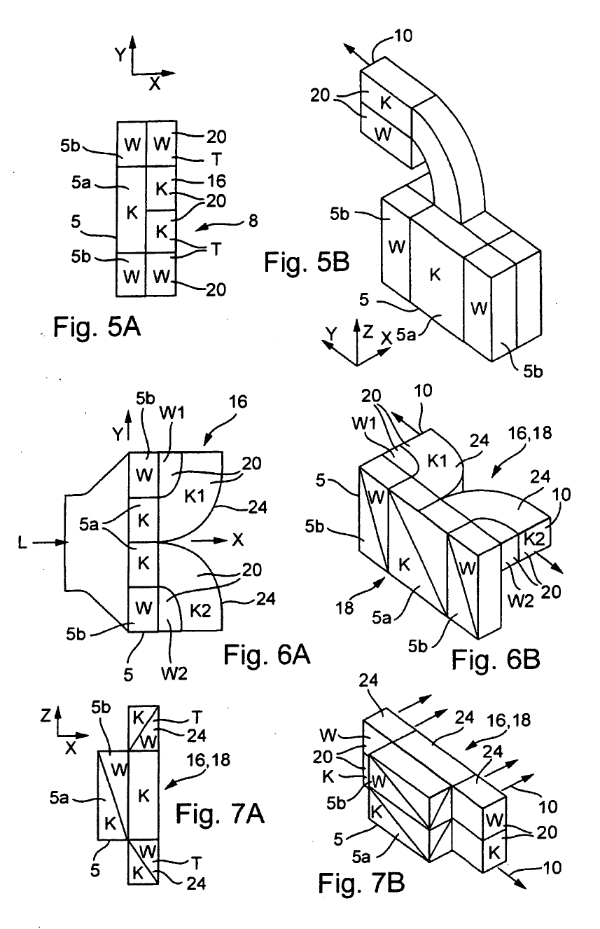

FIG. 5A, 5B show a schematic representation of a heat exchanger with a multi-chamber duct comprising a plurality of chamber ducts,

FIG. 6A, 6B show a schematic representation of a heat exchanger with a multi-chamber duct in the form of a four-chamber duct with subsequent division into two two-chamber ducts having a cold and warm flow duct,

FIG. 7A, 7B show a schematic representation of a heat exchanger with a multi-chamber duct in the form of a two-chamber duct,

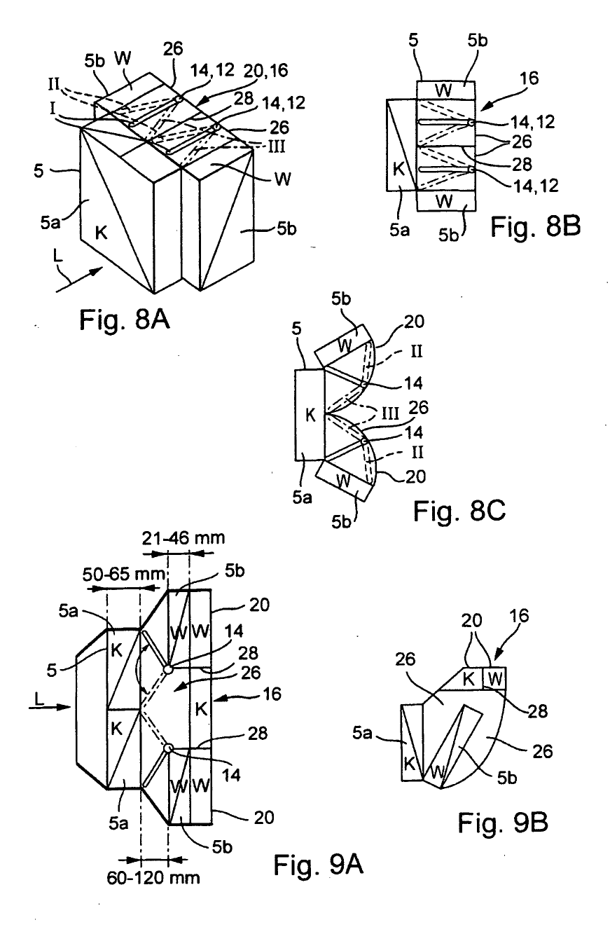

FIG. 8A to 8C show a schematic representation of a heat exchanger with a multi-chamber duct having a mixing chamber duct,

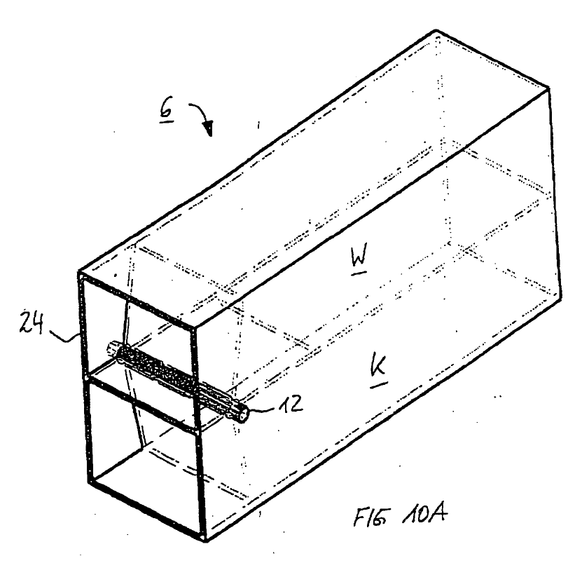

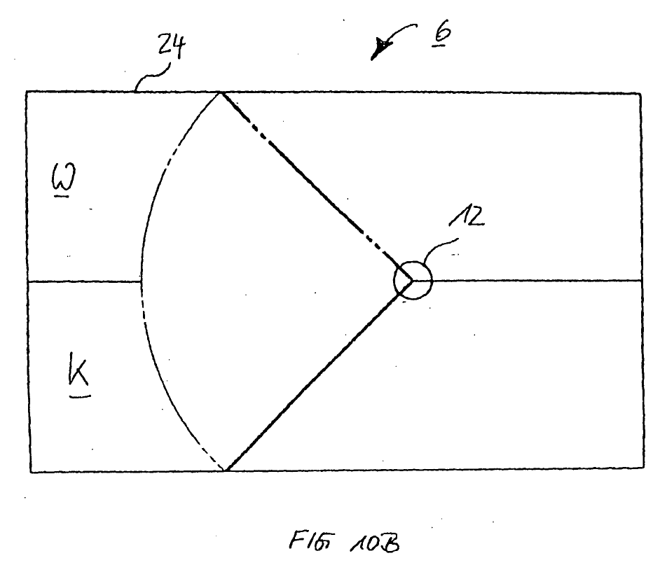

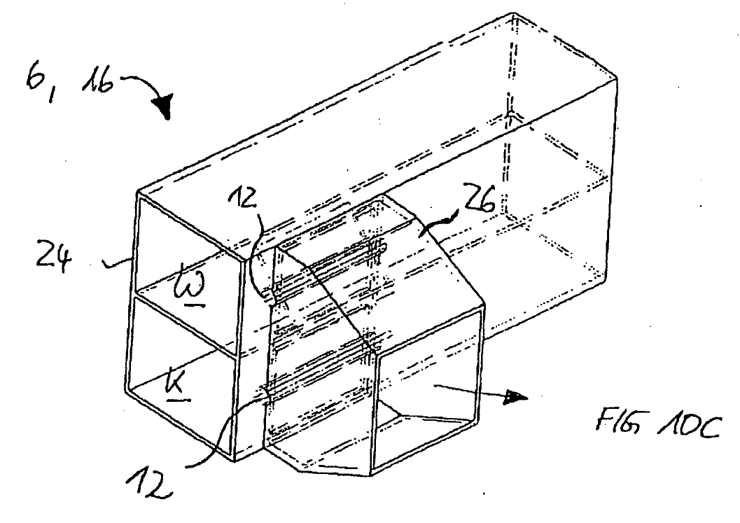

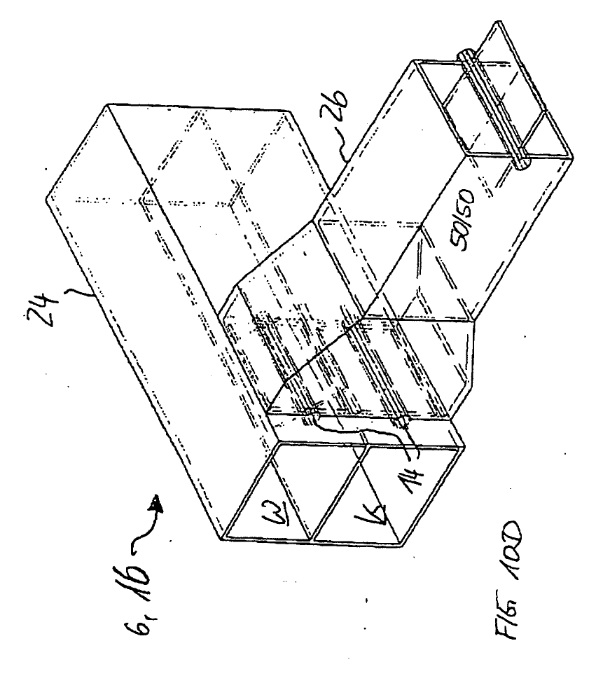

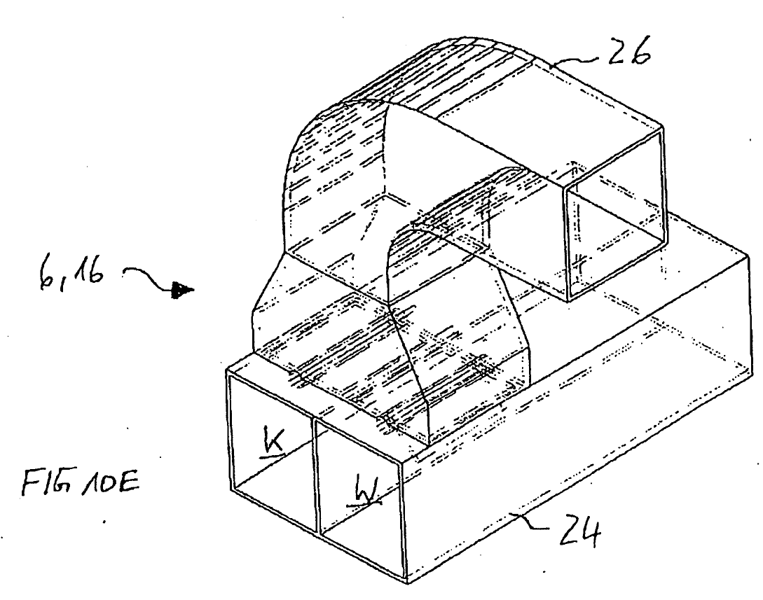

FIG. 9A, 9B show a schematic representation of a further embodiment of a heat exchanger with a multi-chamber duct having a mixing chamber duct,

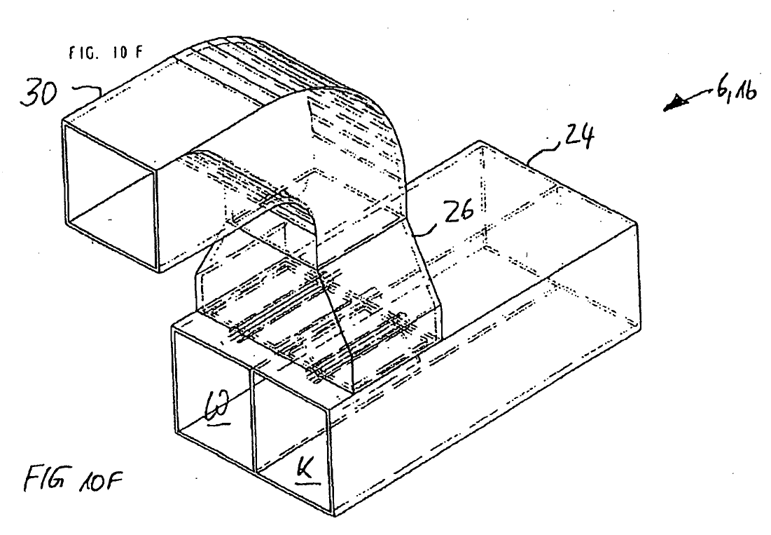

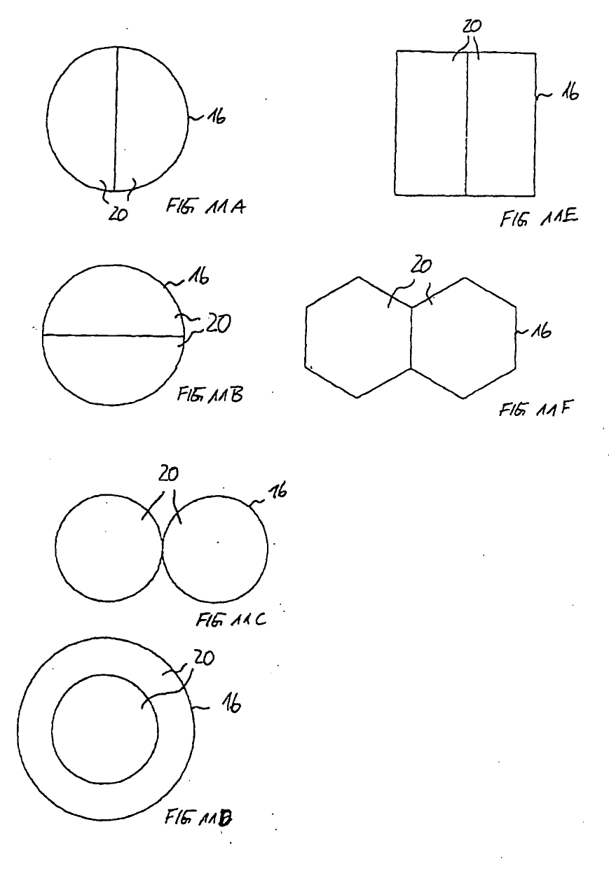

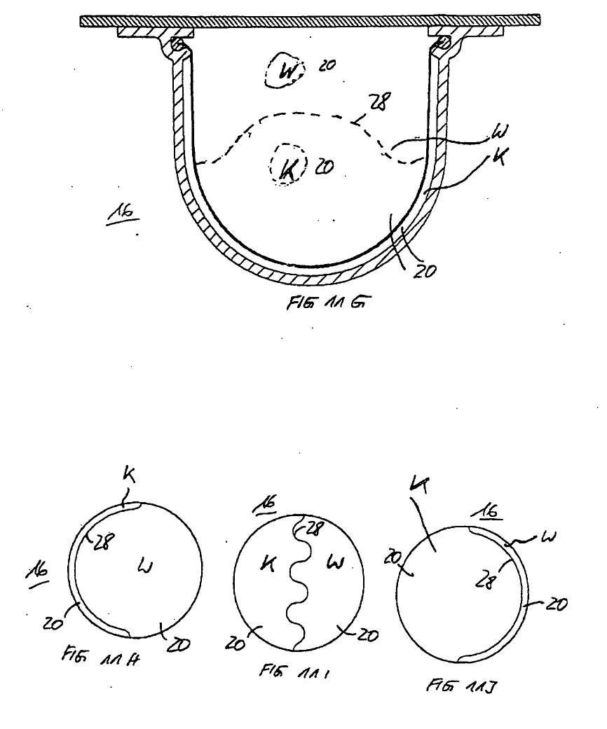

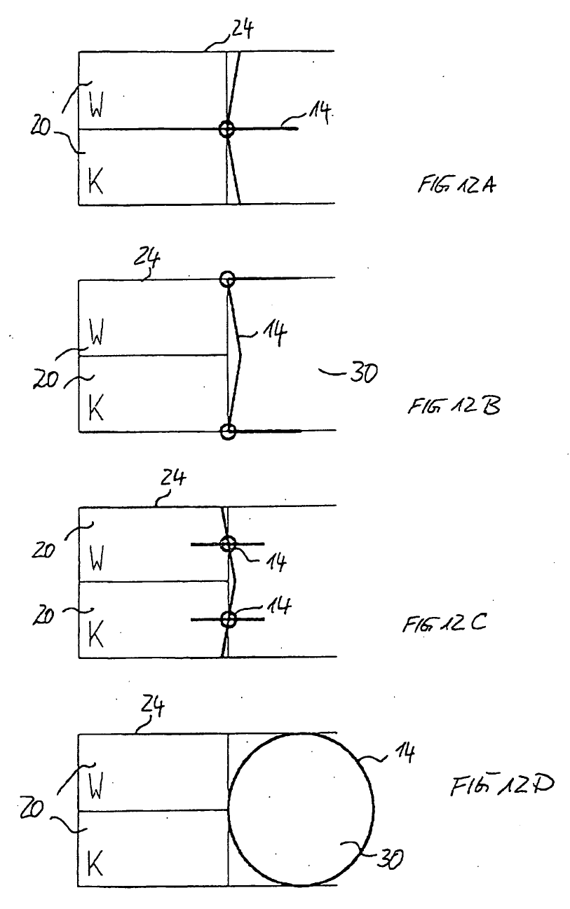

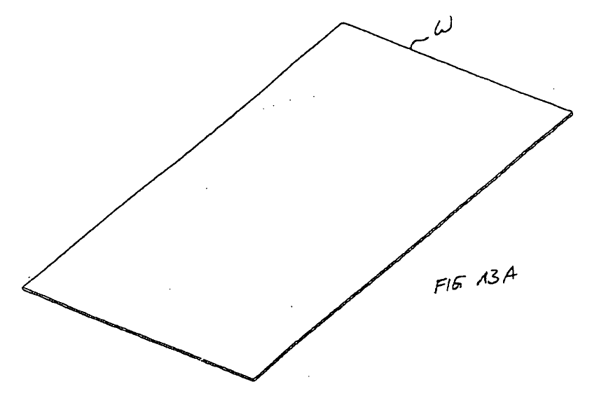

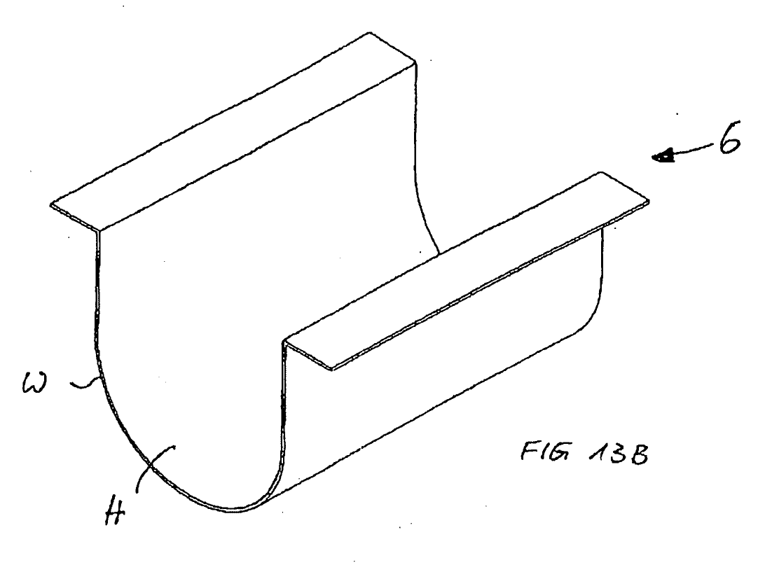

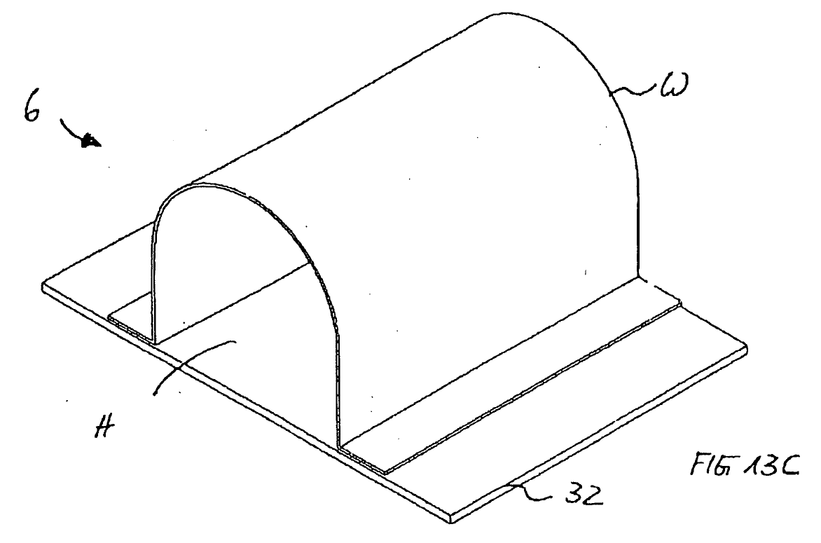

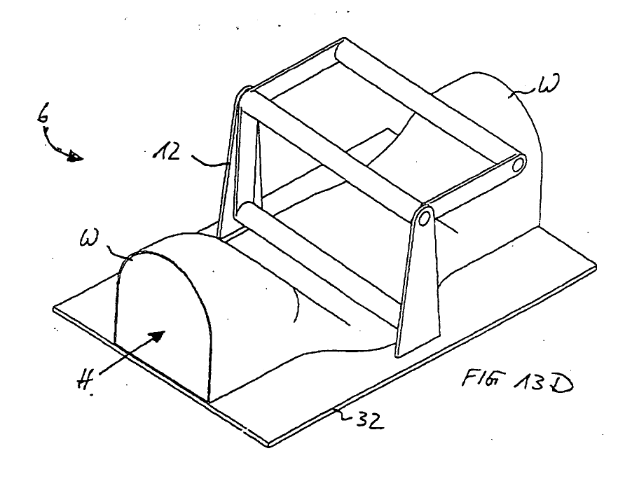

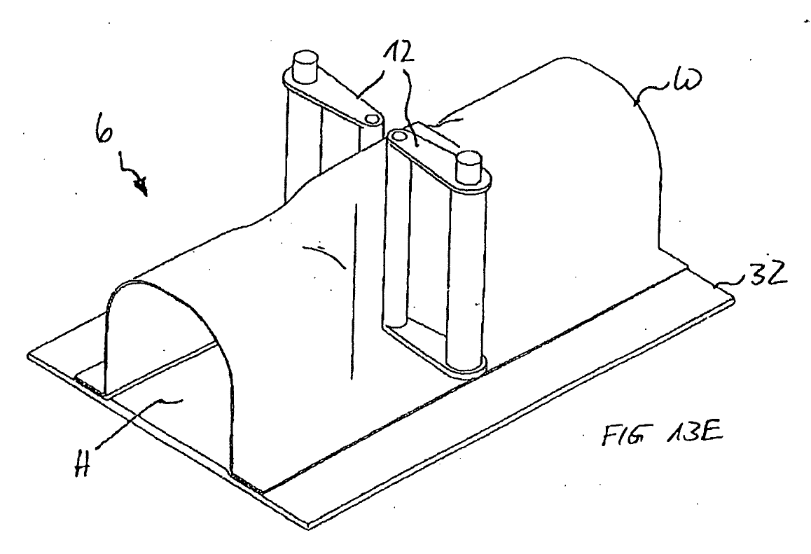

FIG. 10A to 10F show a schematic representation of a heat exchanger with a mixing chamber duct having various mixing and/or closing elements,

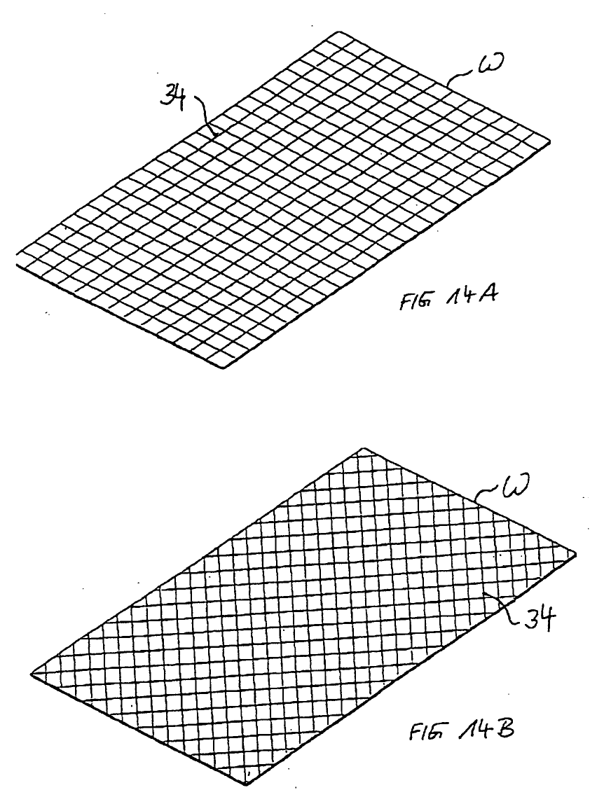

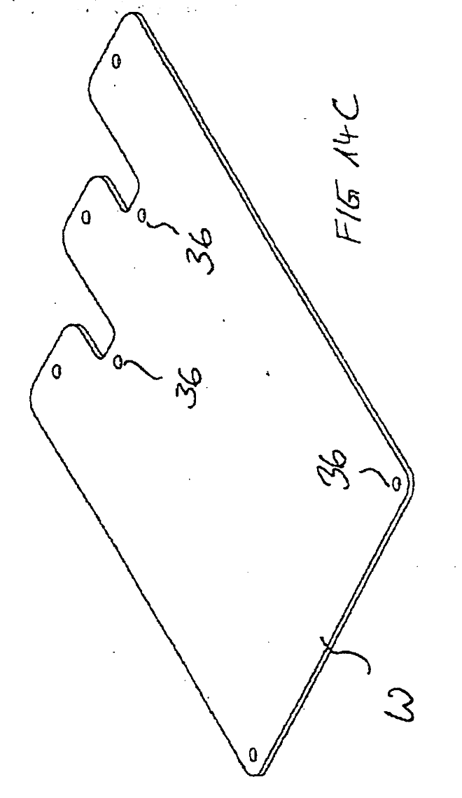

FIG. 11A to 11J show a schematic representation of various cross-sectional forms for a multi-chamber duct,

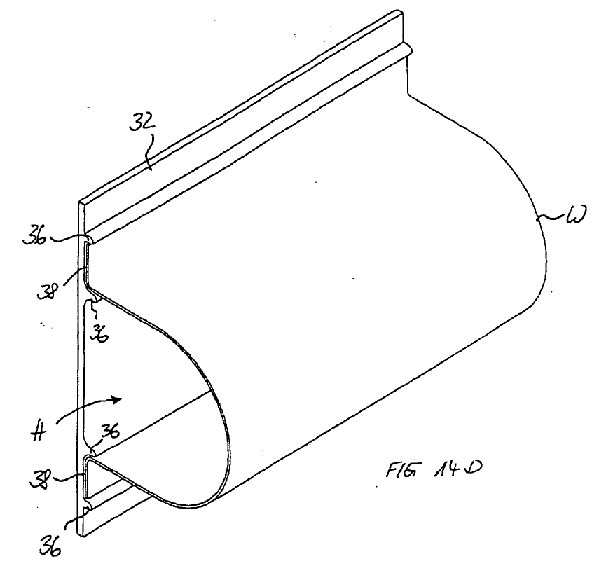

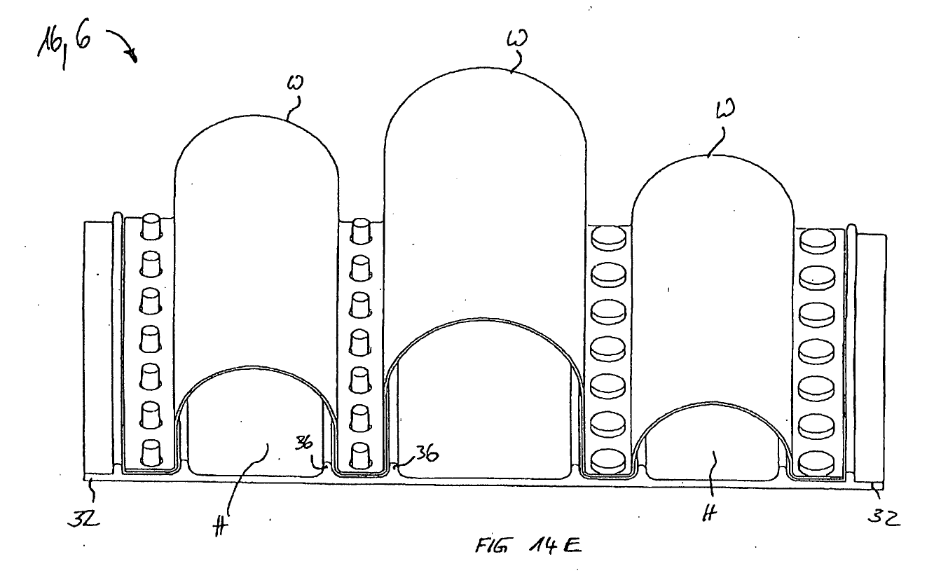

FIG. 12A to 12D show a schematic representation of various mixing elements for a two-chamber duct,

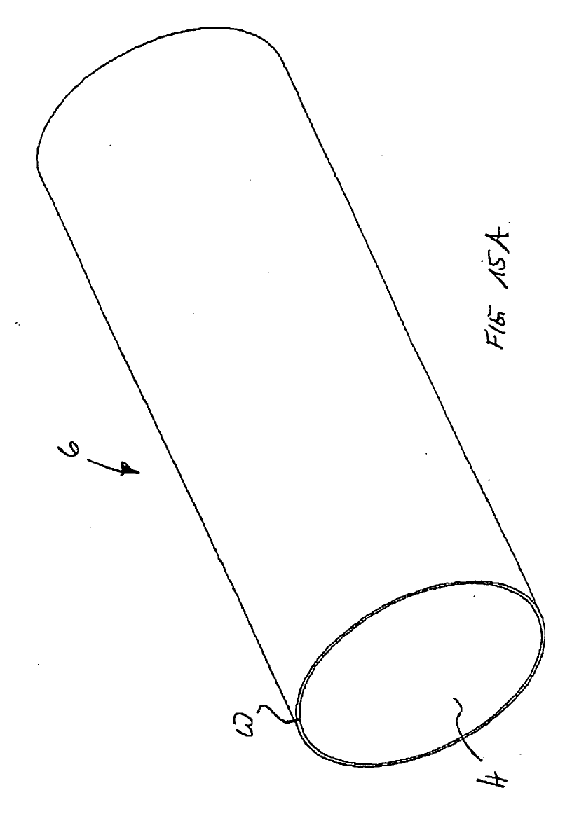

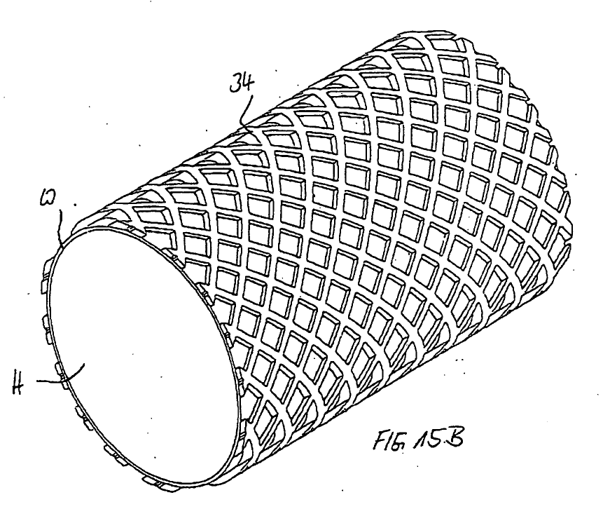

FIG. 13A to 13E show a schematic representation of a flow duct having a duct wall formed from an at least partially deformable material,

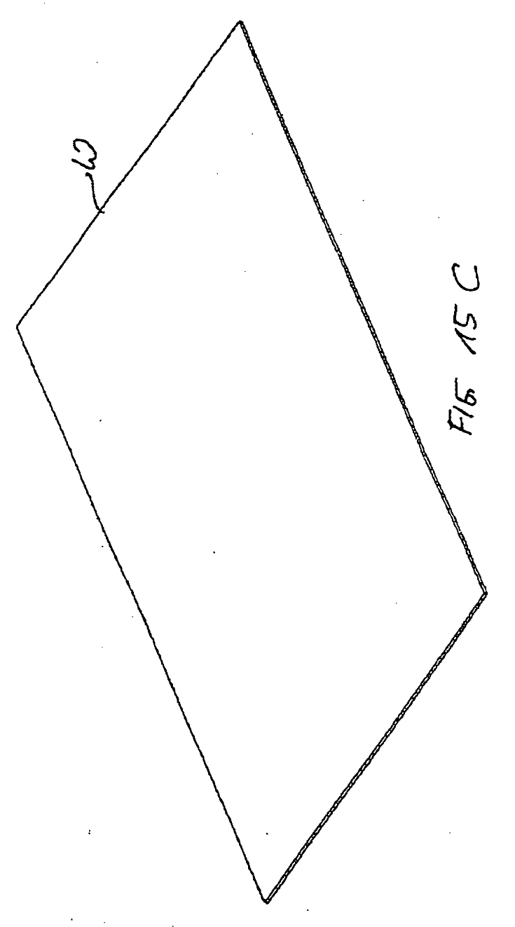

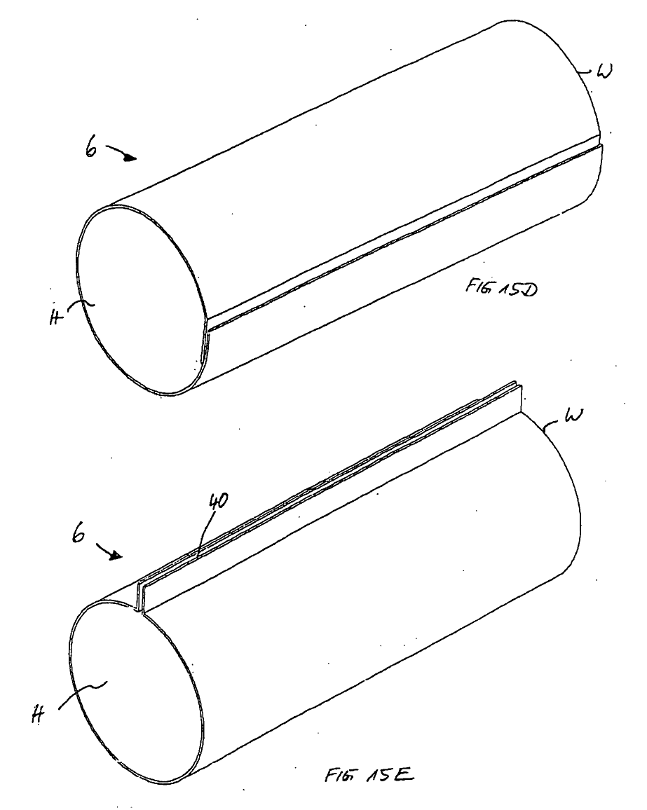

FIG. 14A to 14E show a schematic plan view of the deformable material for forming a duct wall for a flow duct,

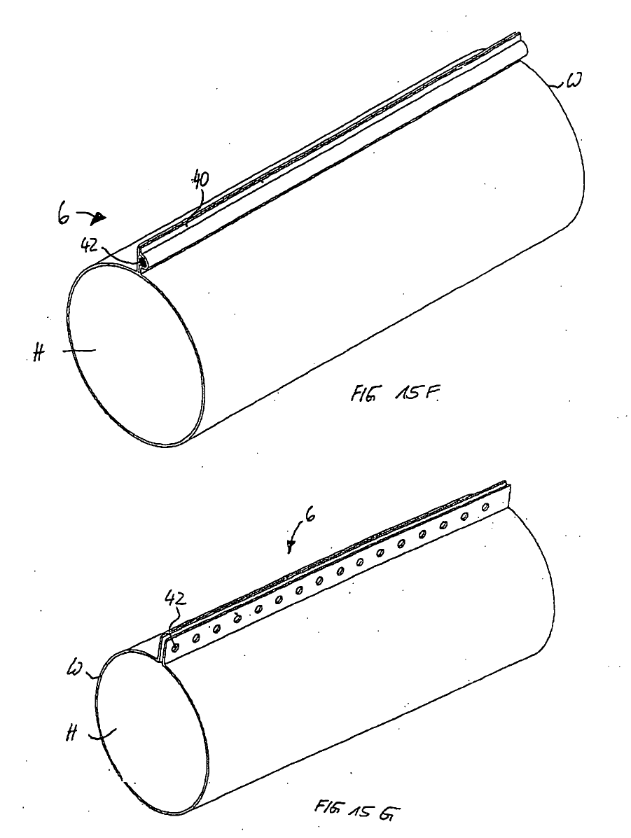

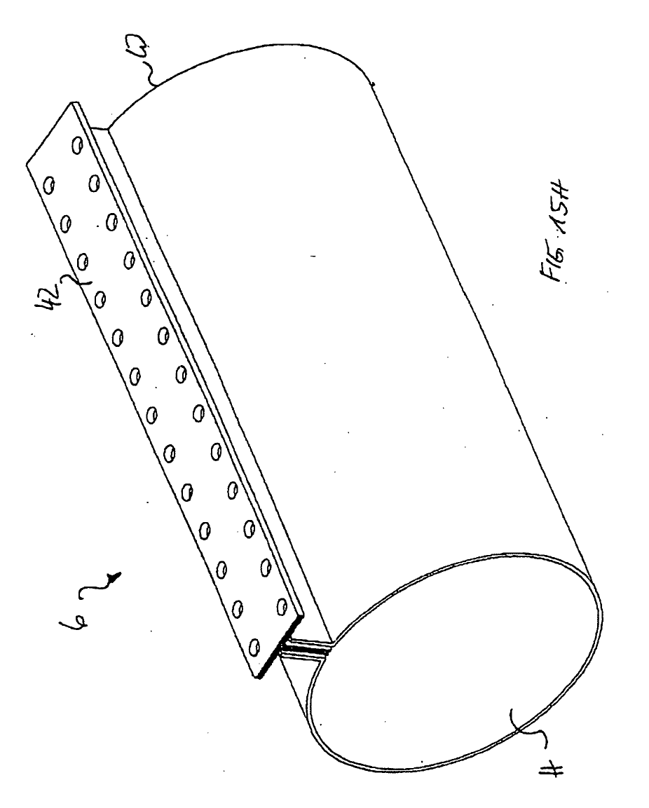

FIG. 15A to 15I show a schematic representation of various embodiments of a hose-like flow duct,

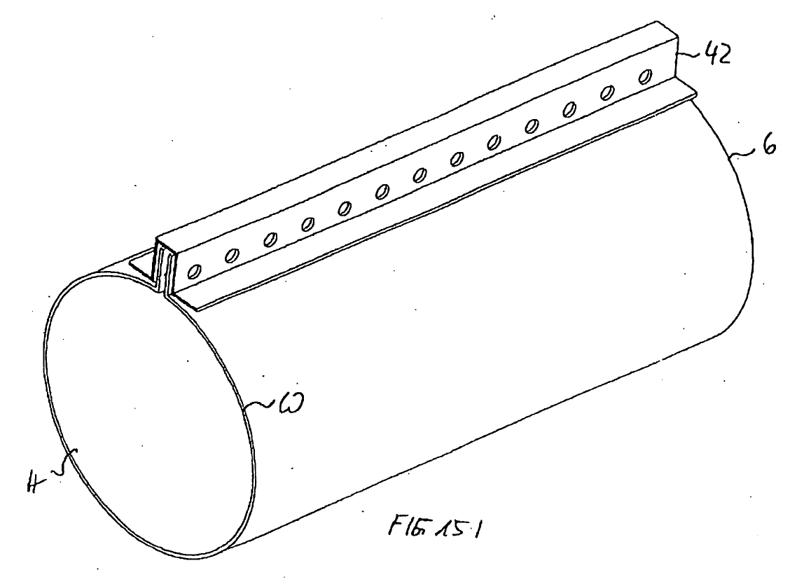

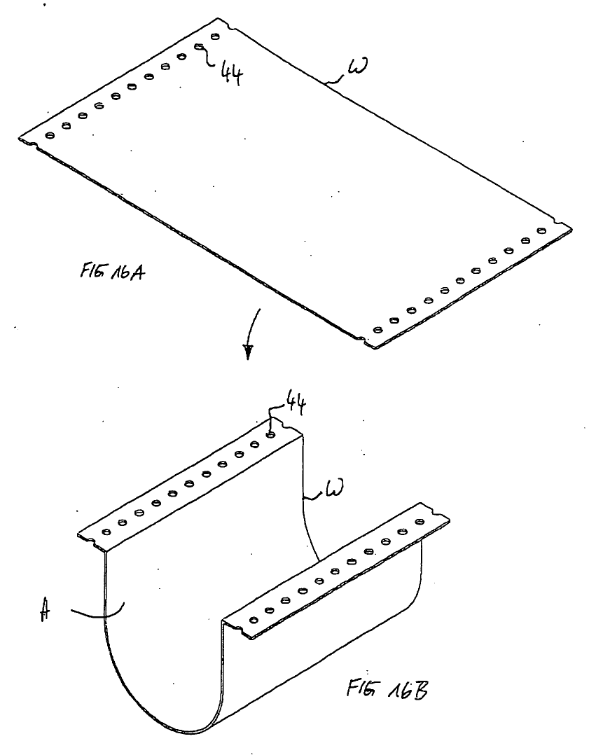

FIG. 16A to 16F show a schematic representation of various forms of fixing for a hose-like flow duct,

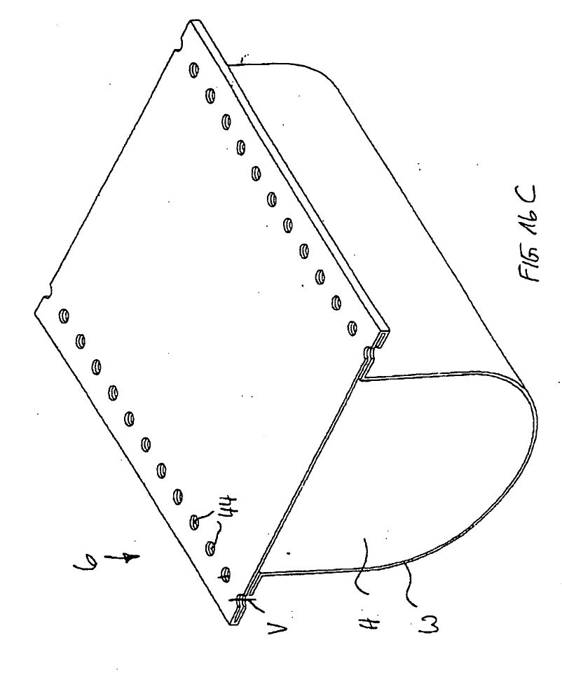

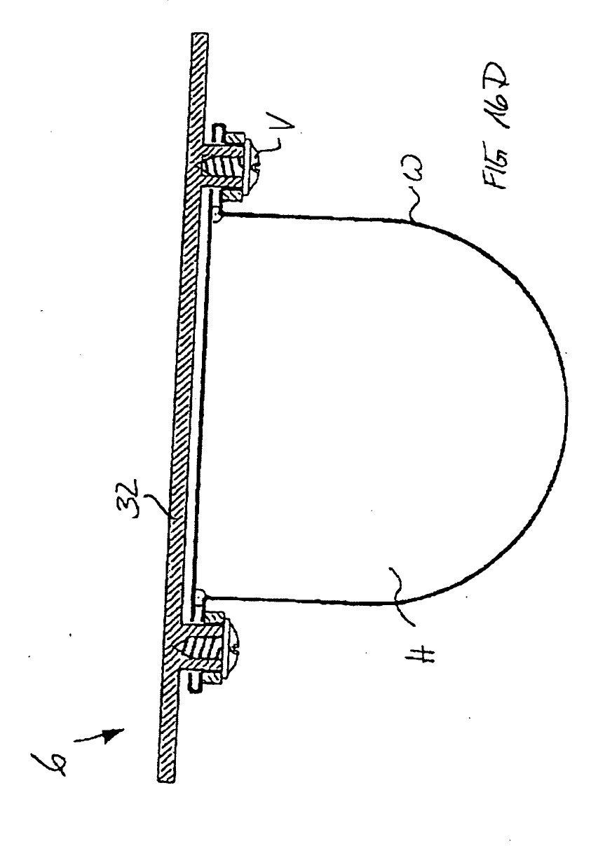

FIG. 17 shows a schematic representation of a flow duct in the form of a full hose,

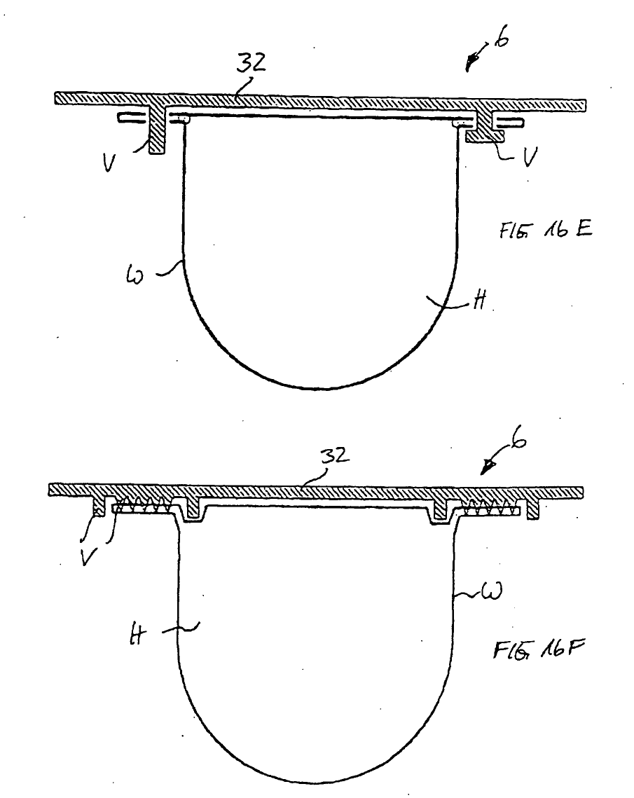

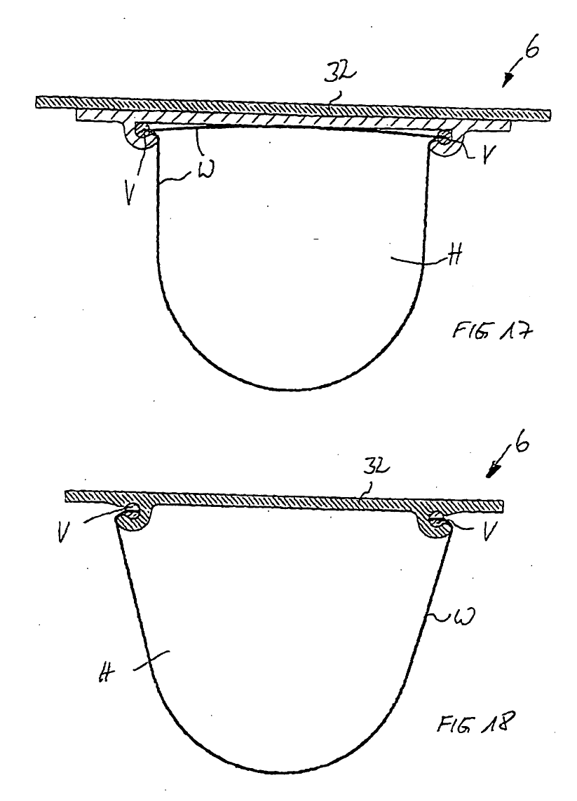

FIG. 18 shows a schematic representation of a flow duct in the form of a half hose, and

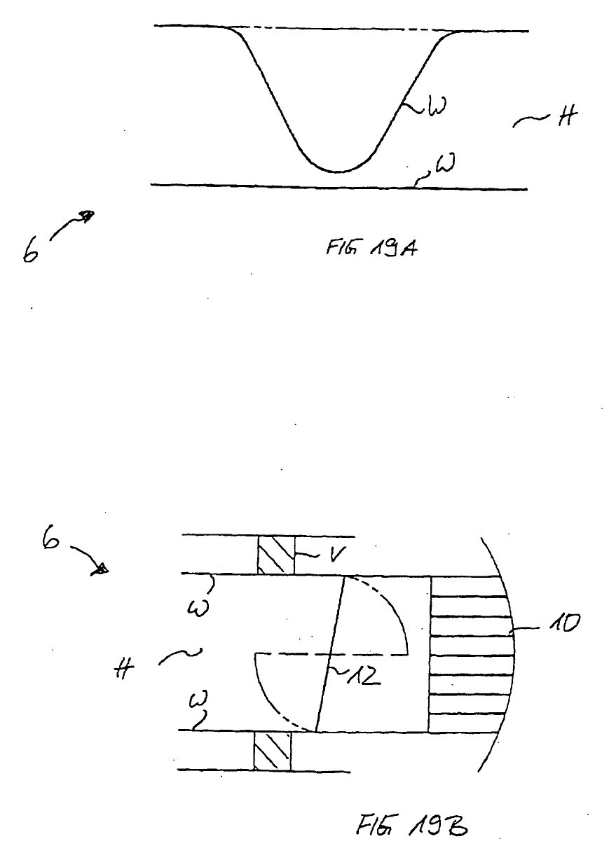

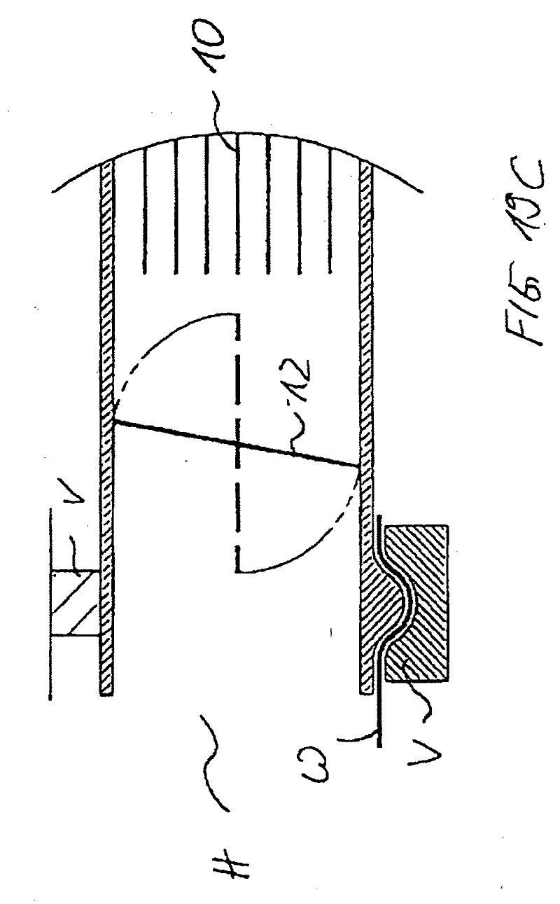

FIG. 19A to 19C show a schematic representation of various closing or mixing elements for a hose-like flow duct.

Corresponding parts are provided with the same reference numerals in all figures.

FIG. 1 shows a device 1 for air distribution in the interior 2 of a vehicle not represented in further detail. The device 1 comprises a ventilating element 4, which depending on the equipment level, may be an integral part of an air conditioning and/or heating system 5. For ventilation of the interior 2 a flow duct 6 is connected to the ventilating element 4. The flow duct 6 is provided with outlet openings 8, which open out directly into air discharge elements 10, which lead into the interior 2. The air discharge elements 10 preferably take the form of nozzles, in particular adjustable nozzles. The flow duct 6 here takes the form of a common duct for all air discharge elements 10.

The ventilating element 4 of the air conditioning and/or heating system 5 serves to generate an overall air flow L having an adjustable air flow quantity, which is delivered to the flow duct 6 as a common volumetric air flow for all air discharge elements 10. For drawing a proportional air flow quantity or partial air flow T at the respective air discharge element 10, regulating elements 12 such as discharge valves are arranged in the outlet openings 8 and/or the air discharge elements 10. The regulating elements 12 are freely adjustable between two limit positions—a closed position and an open position. In addition to the regulating elements 12 at the air discharge elements 10 for the proportional delivery of air into the interior 2, mixing elements 14 such as mixing flaps can also be provided on the air conditioning system 5 for uniform air conditioning and/or regulating the temperature of the overall air flow L. In addition, a shut-off valve 15 is provided for an air discharge element 10 in the form of a diffuser nozzle.

Such a device 1 for the uniform distribution of air and air conditioning that uses a common flow duct 6 makes it possible to dispense with conventional, heavily ramified ventilation ducts. The flow duct 6 common to all air discharge elements 10 brings a 20% to 45% saving in the duct wall material required, compared to conventional ventilation systems. A disadvantage of the common flow duct 6 with regard to a very limited temperature stratification, that is to say temperature differences at the individual air discharge elements 10 or outlet points is negligible in view of the distinct saving in material and hence in weight accruing from the reduction in ducting material, since the temperature differences can be compensated for by corresponding regulation of the already adjustable ventilating element 4 and/or the adjustable air conditioning system 5.

For example, the regulating elements 12 are only ever opened temporarily as a function of the respective position; for example, if the relevant air discharge elements 10a for the “deicing/defrost” function are opened, the air discharge elements 10b opening into the footwell are closed; conversely if the air discharge elements 10b to the footwell are opened, the air discharge elements 10a for deicing are closed. In order to compensate for the perceptible temperature differences that occur when switching over in this way, the ventilating element 4, on the basis of the mixing element 14 of the air conditioning system 5, mixes the temperature according to the desired outlet temperatures and delivers that temperature to the flow duct 6. Similarly the air discharge elements 10c serving only for ventilation are always open when the deicing function is deactivated, and vice versa.

FIG. 2 shows an embodiment of a flow duct 6 in the form of a multi-chamber duct 16. The large or multi-chamber duct 16 here comprises fourteen outer duct walls w1 to w14. Depending on the design of the multi-chamber duct 16, this can take the form of a four-chamber duct 18 having fourteen outer duct walls w1 to w14 and five inner duct walls w15 to w19, or four individual chamber ducts 20a to 20d each having six duct walls w, the multi-chamber duct 16 formed from the chamber ducts 20a to 20d having a total of 24 duct walls w1 to w24. Each chamber duct 20a to 20d preferably opens out into an associated air discharge element 10. For example, the chamber duct 20a serves for the “deicing” function. For this purpose the chamber duct 20a has corresponding outlet openings 8, which open out into the air discharge elements 10a. The chamber ducts 20b to 20d serve for the “ventilation” function and lead via correspondingly arranged outlet openings 8 into the air discharge elements 10c. The chamber duct 20c serves for the “footwell ventilation/heating” function and leads via the relevant outlet openings 8 into the air discharge elements 10b.

FIG. 3 shows a plan view of the flow duct 6 with outlet openings 8 arranged in various positions. The outlet openings 8 are simple adjustable nozzles, for example. The outlet openings 8 or ventilation nozzles may here take the form of a central and/or diffuse outlet. Sections of the flow duct 6 here have a circular and/or semicircular shape.

FIG. 4 shows an alternative embodiment of the device 1 having a flow duct 6 connected to the air conditioning system 5 at the ventilating element 4. An overall air flow L is delivered to the flow duct 6, the flow being led by means of associated partial air flows T into the interior 2 via the air discharge elements 10. Depending on the time or conditions, the flow duct 6 is fed, according to the setting of the air-conditioning system 5, with an overall air flow L, which is composed of a corresponding number of partial air flows T varying as a function of the respective setting.

For example, if the air conditioning system 5 is set to “deicing” only the air discharge elements 10a relevant to deicing are opened to a flow; the air discharge elements 10b and 10c relevant to ventilation remain closed, and vice versa. As a result the flow duct 6 is accordingly subject to double usage, that is to say it is used differently depending on the time and/or conditions. For this purpose the flow duct 6 also has regulating elements 12, in particular a closing element such as a flap, at the air discharge elements 10a (both for the front deicing and for the side deicing). In addition the respective air discharge element 10 may be provided in a manner not shown in further detail with a sensor for registering relevant operating data, for example for registering the temperature, the dew point or the air quantity. By means of the air conditioning systems, the following positions and conditions can be adjusted by way of three regulating elements 12 for each side of the vehicle, arranged in the air discharge elements 10.

TABLE 1

| | | | Side |
|---|---|---|---|
| | Front deicing | Side deicing | ventilation |
| Flap position | Closed | Closed | Closed |
| Flap position | Open | Closed | Closed |
| Flap position | Open | Open | Closed |
| Flap position | Closed | Open | Closed |
| Flap position | Closed | Open | Open |
| Flap position | Closed | Closed | Open |

Where necessary intermediate positions of the regulating elements 12 are also possible, for example for the “antifogging” functions for directing a small air flow at the windshield. For an overall air flow L permitting both side ventilation, side and front deicing and footwell ventilation the flow duct 6 is preferably provided with baffle elements 16, for example dividing walls or flaps.

Such a flow duct 6 according to FIGS. 1 and 4 feeding all air discharge elements 10 in common will permit such a compact overall volume, for example, that a saving of at least 5 liters of overall volume and 0.3 kg in component weight is achieved for each side ventilation duct 6a and 6b of the flow duct 6 compared to a conventional ventilation system having multiple ducts. Conventional ventilation systems by contrast have an overall volume of 30 to 65 liters. Depending on the embodiment and specification an air conditioning and/or heating system 5 comprising multi-chamber ducts 16 may have a 30% to 50% smaller overall volume.

FIGS. 5A to 5B respectively show a plan view and a perspective view of a possible embodiment of an air conditioning and/or heating system 5 with a multi-chamber duct 16 according to one of FIGS. 1 to 4, having a plurality of chamber ducts 20, connected thereto. The air-conditioning and/or heating system 5 in the following figures comprises various heat exchanger arrangements, a heat exchanger 5a for generating a cold air flow K, such as an evaporator, and a heat exchanger 5b for generating a warm air flow W, such as a heating element, being provided in an air distributor housing of an air conditioning system 5 with chamber ducts 20 connected thereto as duct outlets. The heat exchangers 5a and 5b, arranged next to one another in the air flow direction, having separate chamber ducts 20 for the cold air flow K and the warm air flow W represent an air conditioning system 5 without reheat mode. The respective chamber ducts 20 are therefore designed as cold flow duct K or warm flow duct W.

FIGS. 6A and 6B show a further embodiment of an air-conditioning and heating system 5 having a flow duct 6 in the form of a multi-chamber duct 16. In this case the overall air flow L generated by the ventilating element 4 is delivered to the heat exchangers 5a and 5b for the separate cooling or heating of cold air flows K or warm air flows W formed from the overall air flow L. The cold air flows K and the warm air flows W are fed to the multi-chamber duct 16 in the form of a four chamber duct 18. The four-chamber duct 18 comprises four individual chamber ducts 20 subdivided into two cold flow ducts K1, K2 and two warm flow ducts W1, W2. For distributing of the overall air flow L via the air discharge elements 10 along the transverse direction and/or longitudinal direction of the vehicle interior 2, the four-chamber duct 18 is subdivided into two two-chamber ducts 24 each having a cold flow duct and a warm flow duct K1, W1 and K2, W2 respectively.

FIGS. 7A and 7B show a further air-conditioning and heating system 5 having heat exchangers 5a, 5b and multi-chamber duct 18 with two-chamber ducts 24 for air distribution along the longitudinal and/or transverse side of the vehicle interior 2. Depending on the arrangement of the heat exchangers 5a, 5b, a sole circuit KW is formed with a mixing of the cold air flow K and the warm air flow W. That is to say the multi-chamber ducts 16 represented are directly connected to the heat exchangers 5a, 5b—evaporator and heater—of the air conditioning system 5 for mixing the cold air flow K with the warm air flow W. Alternatively mixing can take place at the end of the ducts 20 at the outlet or air discharge element 10.

As already described above, the two-chamber ducts 24 running along the transverse side and/or longitudinal side in FIGS. 7A to 7B have outlet openings 8 with air discharge elements 10 for delivering the respective partial air flow T into the interior 2. Here the partial air flow T is formed by drawing air from the warm and/or cold overall air flow L at the relevant outlet opening 8. Depending on the type and embodiment of the respective outlet opening 8 and/or of the air discharge element 10, the proportional cold air flow K drawn off can be mixed by corresponding regulating elements 12, such as a mixing flap, with the warm air flow W at the relevant outlet point for individual regulation of the temperature.

FIGS. 8A to 8C and 9A to 9B show various embodiments of an air-conditioning and/or heating system 5 for a so-called reheat mode by mixing the cold air flow K with the warm air flow W. For this purpose the heat exchanger 5a designed as evaporator is arranged upstream of the heat exchanger 5b designed as heater in the air flow direction L. As a result, the cold air flow K generated by the heat exchanger 5a is dehumidified and dried by mixing with the warm air flow W generated in the downstream heat exchanger 5b. Depending on the type and embodiment of the flow duct 6 connected to the air conditioning system 5, the chamber ducts 20 take the form of two chambers of a single duct separated by a dividing wall 28 or two ducts separate from one another. The chamber ducts 20 for carrying the dehumidified and dried air are preferably led along the transverse and longitudinal direction of the vehicle in the manner of a ring main. For mixing the warm air flow W with the cold air flow K a chamber duct 20 is arranged as mixing chamber duct 26 or mixing chamber on the flow outlet side downstream of the heat exchangers 5a, 5b. At the same time a mixing element 14, such as a mixing flap, is arranged in the mixing chamber duct 26.

In the exemplary embodiment according to FIGS. 8A to 8C two heat exchangers 5b, each generating a warm air flow W, form the legs of a U-shaped arrangement and the heat exchanger 5a generating the cold air flow K forms the closed underside of the U-shaped arrangement. Two mixing chambers or ducts 26 are arranged between the legs of the U-shaped arrangement. A regulating element 12, in particular a mixing element 14 (=deflector) is provided for each mixing chamber duct 26. In the middle position I the partial air flow T carried in the mixing chamber duct 26 is composed of 50% warm air flow and 50% cold air flow. Thus preheated, the partial air flow T is delivered to the air discharge element 10 via the outlet opening 8. Alternatively, by designing the chamber ducts 20 separately, the respective partial air flow T can be drawn off directly from the respective cold air flow K and/or the warm air flow W via associated outlet openings 8, delivered to the air discharge element 10 and individually mixed only when it reaches the latter. Position II of the mixing element 14 produces a 100% cold air flow and position III a 100% warm air flow. The mixing element 14 is freely adjustable so as to be able to set any desired temperature.

In addition, the air-conditioning and heating system 5 as shown in FIGS. 9A and 9B may have multiple sub-divisions, so that the air conditioning system 5 with reheat mode is formed by an arrangement of two heat exchangers 5a designed as evaporators, with a mixing chamber 26 connected on the outlet side having two heat exchangers 5b designed as heaters and three chamber ducts 20 connected thereto. Various temperature ranges between semi-warm and warm, and semi-cold and cold are adjustable depending on the position of the mixing elements 14 in the mixing chamber duct 26 and the setting of the heat exchangers 5a, 5b. For example, in FIG. 9a the dimensions of the heat exchangers 5a, 5b, in particular their overall depth are represented with ranges from 21 mm to 46 mm, from 50 mm to 65 mm and from 60 mm to 120 mm for the adjustment of the cold air flow K to be generated. The overall depth and the adjustment ranges here vary as a function of the nature, size and type of the basic air conditioning system 5. FIG. 9B shows an alternative arrangement for an air conditioning system 5 with reheat mode, the heat exchanger 5a generating the cold air flow K being arranged transversely to the air flow and the heat exchanger 5b generating the warm air flow W being arranged in a bend in a flow duct 6 running round a bend for dehumidification and drying of the air.

FIGS. 10A to 10F show various embodiments of a mixing chamber duct 26 opening to a two-chamber duct 24 and having various types of mixing elements 14 and/or regulating elements 12. In this case the mixing of the cold air flow with the warm air flow is done by the mixing elements 14 and/or the regulating elements 12 (FIGS. 10B to 10D) and/or by the ducting itself in that, for example, two chambers or chamber ducts 20, for example a two-chamber duct 24, open into a large chamber or chamber duct 20, for example into a single-chamber duct 30 (FIG. 10E, 10F). FIGS. 11A to 11J show various cross-sectional forms for a multi-chamber duct 16. For example, with chamber ducts 20 led side-by-side (FIGS. 11A to 11C, 11E to 11F), the axis running transversely and/or longitudinally in relation to the direction of flow, or chamber ducts 20 led one inside another (FIG. 11D). FIGS. 11G to 11J show a further embodiment of a multi-chamber duct 16, the chamber ducts 20 of which are formed by an elastic, deformable and/or foldable dividing wall 28, which is arranged in the multi-chamber duct 16. In this case the dividing wall 28 is of an elastic material or a film, for example, which if necessary may be longer than a straight wall.

FIGS. 12A to 12D show various mixing elements for a two-chamber duct 24. FIG. 12A shows a mixing element 14 in the form of a mixing flap capable of pivoting by at least 180° and covering both mixing ducts 20. Various mixing elements 14 or regulating elements 12, such as butterfly valves or two individual flaps having a common axis may be correspondingly provided. FIG. 12B shows the transition of a two-chamber duct 24 into a single-chamber duct 30. Here the surface of the inside of the chamber ducts 20 is designed in such a way that swirling and/or dead zones are reliably avoided. For this reason the duct wall of the chamber ducts 20 is preferably elastic and in particular rubber-like. FIGS. 12C and 12D show an associated mixing element 14, in the form of a flap or deflector having a pivoting range of 180° or 360°, for mixing the partial air flows T in each chamber duct 20.

The air distribution device 1, depending on the type and embodiment, may comprise the heat exchanger 5a (=refrigerating unit, in particular an evaporator) and/or the heat exchanger 5b (=heating unit, in particular a heating element), as described above in the various embodiments of an air conditioning and/or heating system 5. In addition, depending on the design of the air conditioning system 5, a reheat mode (=drying) may be possible. In addition a separate drier may be provided. In order to keep the flow velocity in the flow duct 6 low, even at maximum cooling or heating, the flow duct 6 on the inlet side preferably comprises a two-chamber duct 24, to which cold or warm air is admitted by way of a regulating element 12 or a distributing device. Use is thereby made of the total duct cross-section of the flow duct 6. Alternatively, just one duct chamber or one chamber duct 20 may carry a fully warm or fully cold flow and the second chamber duct 20 may be set to a pre-regulated temperature, the two air flows being mixed according to the desired temperature at the respective outlet opening 8 belonging to an air discharge element 10. In this way the overall duct cross-section of the flow duct can be kept as small as possible, in the order of 6000 mm² to 12000 mm².

In a preferred embodiment the flow duct 6 described is arranged in a layer running in the vehicle. For example, the flow duct 6 is arranged in the area of an engine compartment rear bulk or directly underneath a fascia and transversely in the vehicle. The flow duct 6 through its hollow profile can thereby serve as additional reinforcement regardless of its position. In addition functional elements, such as an airbag or steering column can be fixed to the flow duct 6. Where the flow duct 6 is intended to function as transverse reinforcement it is preferably of sandwich-like construction.

For an especially weight-saving and hence lightweight embodiment of the device 1, the flow duct 6 has a duct wall w composed of an at least partially deformable material. FIGS. 13A to 13E represent a possible embodiment of such a flexible flow duct 6 having a formed duct wall w. In this case the flow duct 6 is detachably or permanently fixed to a dimensionally stable surface 32, forming a hose-like hollow space H. The duct wall w, for example, is made by folding a film or a fabric into a U-shape or Ω-shape and joined, for example clipped, clamped, welded or bonded, to the dimensionally stable wall or surface 32, such as a vehicle body surface. Between the dimensionally stable wall 32 and the duct wall w the hollow space H is created, in which the overall air flow L is carried. The flow duct 6 may be provided with outlet openings 8, through which a partial air flow T can escape to the air discharge element 10. FIG. 13C here shows an open flow duct 6 capable of carrying a flow; FIGS. 13D and 13E show a flow duct 6 closed by means of a regulating element 12. By virtue of the flexible duct wall 6, the regulating element 12 may here be formed by constrictions or impressions. This permits simple restriction and/or shut-off functions, which in turn lead to a flow duct 6 that affords savings in material and hence weight, and also saves space.

FIGS. 14A to 14E show a plan view of various embodiments of the deformable material of the duct wall w for the flow duct 6. For reinforcement and to prevent the flexible duct wall w collapsing or sticking together, the deformable material may be provided with a reinforcing fabric 34, such as a meshed structure (FIGS. 14A, 14B). The reinforcing fabric 34 may be of a 3-dimensional design structure. This allows the flow duct 6 to have an especially simple shape. In addition the duct wall w can be constructed from any different laminations or layers as already described above. In particular the duct wall w may be formed from a plurality of layered films, possibly surrounded by a solid material. This leads to particularly good acoustic and thermal insulation characteristics of the flow duct 6. At the same time the flow duct 6 may have layer structures of the duct wall w varying by area or section, for example as a function of the particular place of installation. FIG. 14C shows an embodiment for fixing the flow duct 6 to the dimensionally stable surface 32. For this purpose the extensive material of the duct wall w has perforations 36, which are provided for fixing or positioning the film or the fabric on the surface 32.

In FIGS. 14D to 14E the film or the fabric of the duct wall w is fixed to the surface 32 forming an individual hollow space H (=single-chamber duct 30, FIG. 14D) or a plurality of hollow spaces H (=multi-chamber duct 16, FIG. 14E). For fixing the duct wall w the dimensionally stable surface 32 has prominences 36, such as so-called fixing projections, ribs or protuberances. The duct wall w is joined, for example bonded or welded, into depressions 38 formed between the prominences 36. As an alternative, the duct wall w in FIG. 14E is detachably riveted or screwed to the dimensionally stable surface 32.

FIGS. 15A to 15I show various embodiments of a hose-like flow duct 6. In this case the flow duct 6 is formed by a material of the duct wall w formed as a full hose (FIG. 15A). In FIG. 15B the material of the duct wall w is provided with a reinforcing fabric 34 for reinforcing the flow duct 6. FIGS. 15C to 15E show the manufacture of the hose-shaped flow duct 6 by extrusion or molding of a smooth film to form a hose, the hose according to FIG. 15E being formed in such away that a longitudinal projection 40 is formed for fixing. Alternatively the film may take the form of a shrink film, which is then inflated, forming the flow duct 6.

The hose-like flow duct 6 may be provided with one or more wires or profiles 42 (FIGS. 15F to 15I). Depending on the type and embodiment of the profiles 42 these may be intended for forming and/or connecting film longitudinal edges, for fixing on the dimensionally stable surface 32, for example a fascia, a center console, or a door trim panel, a headliner or a side wall trim panel. FIGS. 16a to 16E show various forms of fixing for a hose-like flow duct 6, the film or the fabric having a corresponding hole pattern 44 according to FIG. 16A for forming and fixing the flow duct 6 according to FIG. 16B. In addition the flow duct 6 may be welded or bonded. FIG. 16D shows a detachable connection V, for example a screwed connection. FIG. 16F shows a welded connection and FIG. 16E shows a riveted or punched connection before and after the riveting or punching process.

The flow duct 6, depending on type and embodiment, may take the form of a full hose (FIG. 17) or a half-hose (FIG. 18). In both FIGS. 17 and 18 the respective flow duct 6 is joined, for example clipped or clamped, in grooves in the surface 32. In order to form a particularly simple restriction and/or shut-off function, the flow duct 6 is, for example, impressed in certain areas (FIG. 19A) or is provided with a regulating element 12 (FIG. 19B).

### LIST OF REFERENCE NUMERALS

1 Device for air distribution
2 Interior of a vehicle
4 Ventilating element
5 Air conditioning system and/or heating system
5a, 5b Heat exchanger
6 Flow duct
8 Outlet opening
10 Air discharge elements
12 Regulating elements
14 Mixing elements
15 Shut-off valve
16 Multi-chamber duct
18 Four-chamber duct
20 Chamber duct
22 Baffle elements
24 Two-chamber duct
26 Mixing chamber duct
28 Dividing wall
30 Single-chamber duct
32 Dimensionally stable surface (=wall)
34 Reinforcing fabric
36 Prominence
38 Depression
40 Longitudinal projection
42 Profile
H Hollow space
K Cold air flow
L Overall air flow
T Partial air flow
W Warm air flow

1. A device (1) for air distribution in the interior (2) of a vehicle having a ventilating element (4) for generating an air flow (L) and having at least one flow duct (6) connected to the ventilating element (4) together with a plurality of air discharge elements (10) leading into the interior (2), characterized in that the flow duct (6) takes the form of a common multi-chamber duct (16) for a plurality of air discharge elements (10) and has a plurality of outlet openings (8) which open directly into the air discharge elements (10).

2. The device as claimed in claim 1, characterized in that the multi-chamber duct (16) takes the form of a two-chamber duct (24).

3. The device as claimed in claim 1, characterized in that the multi-chamber duct (16) is sub-divided into a plurality of chamber ducts (20).

4. The device as claimed in claim 3, characterized in that an individual chamber duct (20) takes the form of a two-chamber duct (24) or an individual mixing chamber duct (26).

5. The device as claimed in claim 3, characterized in that each chamber duct (20) opens out into an associated air discharge element (10).

6. The device as claimed in claim 3, characterized in that one chamber duct (20) takes the form of a cold flow duct (K) and another takes the form of a warm flow duct (W).

7. The device as claimed in claim 1, characterized in that the respective outlet opening (8) comprises at least one regulating element (12) and/or a mixing element (14).

8. The device as claimed in claim 1, characterized in that the flow duct (6) is provided with at least one regulating element (12).

9. The device as claimed in claim 1, characterized in that a measuring sensor for registering relevant operating data is provided on at least one air discharge element (10).

10. The device as claimed in claim 1, characterized in that the multi-chamber duct (16) is arranged running longitudinally and/or transversely along a vehicle shell.

11. The device as claimed in claim 1, characterized in that the multi-channel duct (16) takes the form of a ring main.

12. A flow duct (6) for use in a device (1) for air distribution in a vehicle as claimed in claim 1, characterized by a duct wall (w, w1 to w24) of an at least partially deformable material, which is shaped and detachably fixed, forming a hose-like hollow space (H).

13. The flow duct as claimed in claim 12, characterized in that the material is fixed to a dimensionally stable surface (32), forming a hollow space (H).

14. The flow duct as claimed in claim 12, characterized in that the material itself is formed like a hose.

15. The flow duct as claimed in claim 1, characterized in that the deformable material takes the form of a film-like material.

16. The flow duct as claimed in claim 1, characterized in that the deformable material takes the form of a fabric-like material.

17. The flow duct as claimed in claim 1, characterized in that the duct wall (w) is fixed in the manner of a clip.

18. The flow duct as claimed in claim 1, characterized in that the deformable material is provided with a profile (42).

19. The flow duct as claimed in claim 1, characterized in that the duct wall (w, w1 to w24) is formed from a plurality of layered films, which are arranged on the dimensionally stable surface (32), forming a hollow space (H).

20. The flow duct as claimed in claim 19, characterized in that the layered films are additionally enclosed by a solid material.

21. The flow duct as claimed in claim 1, characterized in that an elastic, deformable and/or foldable dividing wall (28) is arranged between two chambers (20) of a multi-chamber duct (16).

22. A method for air distribution in the interior (2) of a vehicle, characterized in that an overall air flow (L) is generated by means of a ventilating element (4) and delivered to a flow duct (6) connected to the ventilating element (4), an associated partial air flow (T) in each case being drawn from the overall air flow (L) by way of a plurality of air discharge elements (10) opening into the interior (2).

23. The method as claimed in claim 22, characterized in that the overall air flow (L) is made up of the sum of all partial air flows (T).

24. The method as claimed in claim 22, characterized in that the overall air flow (L) is made up of a corresponding number of partial air flows (T) varying as a function of the time and/or conditions.
